(19) United States
(12) Patent Application Publication
(10) Pub. No.: US 2009/0300423 A1
(43) Pub. Date: Dec. 3, 2009

(54) SYSTEMS AND METHODS FOR SOFTWARE TEST MANAGEMENT IN CLOUD-BASED NETWORK

(76) Inventor: James Michael Ferris, Cary, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 12/127,940

(22) Filed: May 28, 2008

(51) Int. Cl. G06F 11/30

(52) U.S. Cl. 714/38; 714/E11.179

(57) ABSTRACT

Embodiments relate to systems and methods for testing and evaluating software in the network cloud. A developer or other operator may wish to debug, modify, or update a set of test software based on testing of that software. The developer can instantiate a set of virtual servers or other test beds in the cloud, and install the subject software to the virtual test beds. A test management module can monitor the execution of the set of test software on the set of virtual test beds, to detect execution faults, measure processing performance, stress-test the software with predetermined data inputs, and manage other aspects of software life cycle development. The test management module can provide or access a set of application programming interfaces to a set of software tools external to the cloud, so that the set of test software can be tested and optimized using external programming development tools.

### FIELD

The present teachings relate to software test management in a cloud-based network, and more particularly to platforms and techniques for performing software evaluation and testing on virtual test beds while interfacing to standardized software diagnostic tools.

### BACKGROUND OF RELATED ART

The management of the software development cycle has been facilitated in recent years by the availability of automated tools for testing software as it is built, tested and debugged. Different software tools are commercially available which can take an application or other piece of software as it is built and test that software for reliability. For instance, bug database packages can store and index different bugs or incompatibilities in the software as they are reported. Other packages can exercise the memory management of an application or other piece of software, for example to discover if there are memory leaks or other memory management issues present in the design. Other software tools can test the performance or data handling capabilities of a piece of software in development, allowing the code to be refined according to the developer's objectives.

With the advent of cloud-based network computing, many tasks that previously depended on on-premise computer hardware such as servers or other platforms can be now hosted in the cloud. The cloud in general represents a computing infrastructure from which a user can instantiate a desired amount of computing power configured in desired ways to achieve desired applications or processes, all without requiring physical on-premise hardware. By configuring and instantiating a set of virtual machines on an economical, relatively short-term basis a user can activate computing resources on a targeted basis, without a need to invest in permanent processing infrastructure.

The advantages of cloud-based computing can be leveraged by software developers who wish to built a set of virtual servers or other test beds, and develop applications or other software supported by the resources in the cloud. However, migrating the task of software life cycle development to the cloud can still involve some drawbacks or disadvantages. One of those considerations is the fact that virtual test beds hosted in the cloud may not be configured to communicate or be compatible with the entire suite of software development tools available to the professional developer, as noted above. It may be desirable to provide methods and systems for performing software testing in a cloud-based network, in which inter-process communication including interfaces to existing and future software development tools are integrated into the development platform.

### DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an overall cloud system architecture in which various embodiments of the present teachings can be practiced;

FIG. 2 illustrates an overall cloud system architecture including multiple cloud arrangements in which various embodiments of the present teachings can be practiced in another regard, according to various embodiments;

FIG. 3 illustrates a network configuration in which a cloud management system can support various software diagnostic and life cycle functions including interfacing to external software test tools, according to various embodiments;

FIG. 4 illustrates an exemplary hardware configuration for a cloud management system, according to various embodiments; and

FIG. 5 illustrates a flowchart for overall software development and diagnostic processing in a cloud computing environment, according to various embodiments.

### DESCRIPTION OF EMBODIMENTS

Embodiments of the present teachings relate to systems and methods for software test management in a cloud-based network. More particularly, embodiments relate to platforms and techniques in which a software developer or other user can instantiate a set of servers or other virtual test beds, in the cloud. The set of virtual test beds can comprise, for example, a representative server having a specified amount of processing power, a specified amount of random access memory, and loaded with a selected operating system. The set of virtual test beds can, in embodiments, reflect an expected or target configuration of a hardware machine for which the developer is developing application or other software.

The software developer or other user can specify the installation of one or more applications, or other pieces of software on the set of virtual test beds as a software test load, or set of software components to be tested. The software test load can comprise one or more software modules, applications, utilities, functions, or programs. The software test load can be installed and the subject software can be initiated on the set of virtual test beds. In embodiments, the set of virtual test beds can be instantiated, configured and managed by a cloud management system associated with the cloud. In embodiments, the set of virtual test beds can be monitored by a virtual test monitor that can retrieve execution data from the set of virtual test beds indicating the execution state of the software test load executing on those virtual machines.

The virtual test monitor or other logic can also provide an interface between the test software executing on the virtual test beds, and an external set of test tools. The external set of test tools can comprise one or more software testing tools, applications, or suites, such as tools that stress, evaluate, or otherwise test the execution behavior of the subject software under test. The interface to the external set of test tools can be or include a set of application programming interfaces (APIs) that permit the software or operating system executing on the set of virtual test beds to exchange data and calls with the external tools. A software developer can therefore deploy an existing set of software debugging, diagnostic or other test tools or packages to validate the software being evaluated on the set of virtual test beds using established or available software life cycle management tools, without having to specially code or adapt the software under test. These and other embodiments described herein address the various noted shortcomings in known software diagnostic technology, and provide a user or network operator with an enhanced ability to migrate software testing and development functions to the cloud while retaining the ability to use existing software evaluation and management packages.

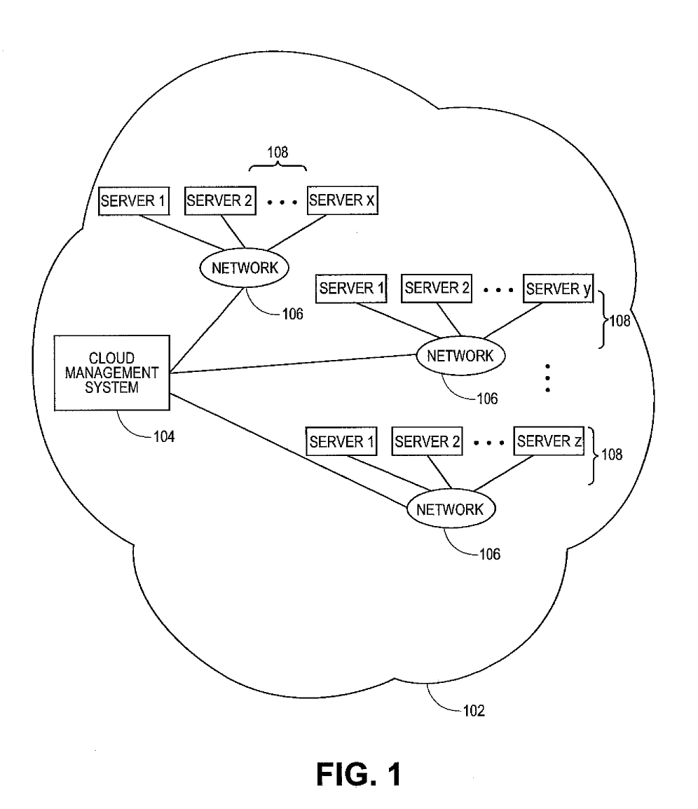

Embodiments described herein can be implemented in or supported by a cloud network architecture. As used herein, a “cloud” can comprise a collection of resources that can be invoked to instantiate a virtual machine, process, or other resource for a limited or defined duration. As shown for example in FIG.1, the collection of resources supporting a cloud 102 can comprise a set of resource servers 108 configured to deliver computing components needed to instantiate a virtual machine, process, or other resource. For example, one group of resource servers can host and serve an operating system or components thereof to deliver to and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software. Other types of resource servers are possible.

In embodiments, the entire set of resource servers 108 or other hardware or software resources used to support the cloud 102 along with its instantiated virtual machines is managed by a cloud management system 104. The cloud management system 104 can comprise a dedicated or centralized server and/or other software, hardware, and network tools that communicate via network 106 such as the Internet or other public or private network with all sets of resource servers to manage the cloud 102 and its operation. To instantiate a new set of virtual machines, a user can transmit an instantiation request to the cloud management system 104 for the particular type of virtual machine they wish to invoke for their intended application. A user can for instance make a request to instantiate a set of virtual machines configured for email, messaging or other applications from the cloud 102. The request can be received and processed by the cloud management system 104, which identifies the type of virtual machine, process, or other resource being requested. The cloud management system 104 can then identify the collection of resources necessary to instantiate that machine or resource. In embodiments, the set of instantiated virtual machines or other resources can for example comprise virtual transaction servers used to support Web storefronts, or other transaction sites.

In embodiments, the user's instantiation request can specify a variety of parameters defining the operation of the set of virtual machines to be invoked. The instantiation request, for example, can specify a defined period of time for which the instantiated machine or process is needed. The period of time can be, for example, an hour, a day, or other increment of time. In embodiments, the user's instantiation request can specify the instantiation of a set of virtual machines or processes on a task basis, rather than for a predetermined amount of time. For instance, a user could request resources until a software update is completed. The user's instantiation request can specify other parameters that define the configuration and operation of the set of virtual machines or other instantiated resources. For example, the request can specify an amount of processing power or input/output (I/O) throughput the user wishes to be available to each instance of the virtual machine or other resource. In embodiments, the requesting user can for instance specify a service level agreement (SLA) acceptable for their application. Other parameters and settings can be used. One skilled in the art will realize that the user's request can likewise include combinations of the foregoing exemplary parameters, and others.

When the request to instantiate a set of virtual machines or other resources has been received and the necessary resources to build that machine or resource have been identified, the cloud management system 104 can communicate with one or more set of resource servers 108 to locate resources to supply the required components. The cloud management system 104 can select providers from the diverse set of resource servers 108 to assemble the various components needed to build the requested set of virtual machines or other resources. It may be noted that in some embodiments, permanent storage such as hard disk arrays may not be included or located within the set of resource servers 108 available to the cloud management system 104, since the set of instantiated virtual machines or other resources may be intended to operate on a purely transient or temporary basis. In embodiments, other hardware, software or other resources not strictly located or hosted in the cloud can be leveraged as needed. For example, other software services that are provided outside of the cloud 102 and hosted by third parties can be invoked by in-cloud virtual machines. For further example, other non-cloud hardware and/or storage services can be utilized as an extension to the cloud 102, either on an on-demand or subscribed or decided basis.

With the resource requirements identified, the cloud management system 104 can extract and build the set of virtual machines or other resources on a dynamic or on-demand basis. For example, one set of resource servers 108 may respond to an instantiation request for a given quantity of processor cycles with an offer to deliver that computational power immediately and guaranteed for the next hour. A further set of resource servers 108 can offer to immediately supply communication bandwidth, for example on a guaranteed minimum or best-efforts basis. In other embodiments, the set of virtual machines or other resources can be built on a batch basis or at a particular future time. For example, a set of resource servers 108 may respond to a request for instantiation at a programmed time with an offer to deliver the specified quantity of processor cycles within a specific amount of time, such as the next 12 hours.

The cloud management system 104 can select group of servers in the set of resource servers 108 that match or best match the instantiation request for each component needed to build the virtual machine or other resource. The cloud management system 104 can then coordinate the integration of the completed group of servers from the set of resource servers 108, to build and launch the requested set of virtual machines or other resources. The cloud management system 104 can track the combined group of servers selected from the set of resource servers 108, or other distributed resources that are dynamically or temporarily combined, to produce and manage the requested virtual machine population or other resources.

In embodiments, the cloud management system 104 can generate a resource aggregation table that identifies the various sets of resource servers that will be used to supply the components of the virtual machine or process. The sets of resource servers can be identified by unique identifiers such as, for instance, Internet protocol (IP) addresses or other addresses. The cloud management system 104 can register the finalized group of servers in the set resource servers 108 contributing to an instantiated machine or process.

The cloud management system 104 can then set up and launch the initiation process for the virtual machines, processes, or other resources to be delivered from the cloud. The cloud management system 104 can for instance transmit an instantiation command or instruction to the registered group of servers in set of resource servers 108. The cloud management system 104 can receive a confirmation message back from each participating server in set of resource servers 108 indicating a status regarding the provisioning of their respective resources. Various sets of resource servers may confirm, for example, the availability of a dedicated amount of processor cycles, amounts of electronic memory, communications bandwidth, or applications or other software prepared to be served.

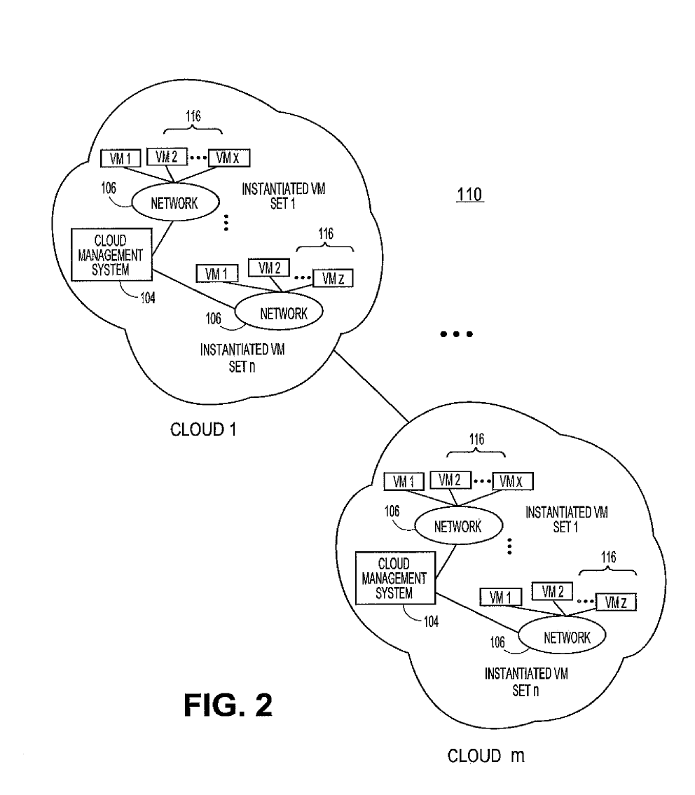

As shown for example in FIG. 2, the cloud management system 104 can then instantiate one or more than one set of virtual machines 116, or other processes based on the resources supplied by the registered set of resource servers 108. In embodiments, the cloud management system 104 can instantiate a given number, for example, 10, 500, 1000, or other numbers of virtual machines to be made available to users on a network 114, such as the Internet or other public or private network. Each virtual machine can be assigned an instantiated machine ID that can be stored in the resource aggregation table, or other record or image of the instantiated population. Additionally, the cloud management system 104 can store the duration of each virtual machine and the collection of resources utilized by the complete set of instantiated virtual machines 116.

In embodiments, the cloud management system 104 can further store, track and manage a user's identity and associated set of rights or entitlements to software, hardware, and other resources. Each user that populates a set of virtual machines in the cloud can have specific rights and resources assigned and made available to them. The cloud management system 104 can track and configure specific actions that a user can perform, such as provision a set of virtual machines with software applications or other resources, configure a set of virtual machines to desired specifications, submit jobs to the set of virtual machines or other host, manage other users of the set of instantiated virtual machines 116 or other resources, and other privileges or actions. The cloud management system 104 can further generate records of the usage of instantiated virtual machines to permit tracking, billing, and auditing of the services consumed by the user. In embodiments, the cloud management system 104 can for example meter the usage and/or duration of the set of instantiated virtual machines 116, to generate subscription billing records for a user that has launched those machines. Other billing or value arrangements are possible.

The cloud management system 104 can configure each virtual machine to be made available to users of the network 114 via a browser interface, or other interface or mechanism. Each instantiated virtual machine can communicate with the cloud management system 104 and the underlying registered set of resource servers 108 via a standard Web application programming interface (API), or via other calls or interfaces. The set of instantiated virtual machines 116 can likewise communicate with each other, as well as other sites, servers, locations, and resources available via the Internet or other public or private networks, whether within a given cloud 102 or between clouds.

It may be noted that while a browser interface or other front-end can be used to view and operate the set of instantiated virtual machines 116 from a client or terminal, the processing, memory, communications, storage, and other hardware as well as software resources required to be combined to build the virtual machines or other resources are all hosted remotely in the cloud 102. In embodiments, the set of virtual machines 116 or other resources may not depend on or require the user's own on-premise hardware or other resources. In embodiments, a user can therefore request and instantiate a set of virtual machines or other resources on a purely off-premise basis, for instance to build and launch a virtual storefront or other application.

Because the cloud management system 104 in one regard specifies, builds, operates and manages the set of instantiated virtual machines 116 on a logical level, the user can request and receive different sets of virtual machines and other resources on a real-time or near real-time basis, without a need to specify or install any particular hardware. The user's set of instantiated machines 116, processes, or other resources can be scaled up or down immediately or virtually immediately on an on-demand basis, if desired. In embodiments, the various sets of resource servers that are accessed by the cloud management system 104 to support a set of instantiated virtual machines 116 or processes can change or be substituted, over time. The type and operating characteristics of the set of instantiated virtual machines 116 can nevertheless remain constant or virtually constant, since instances are assembled from abstracted resources that can be selected and maintained from diverse sources based on uniform specifications.

In terms of network management of the set of virtual machines 116 that have been successfully configured and instantiated, the cloud management system 104 can perform various network management tasks including security, maintenance, and metering for billing or subscription purposes. The cloud management system 104 of a given cloud can 102, for example, install or terminate applications or appliances on individual machines. The cloud management system 104 can monitor operating virtual machines to detect any virus or other rogue process on individual machines, and for instance terminate the infected application or virtual machine. The cloud management system 104 can likewise manage an entire set of instantiated clients 116 or other resources on a collective basis, for instance, to push or delivery a software upgrade to all active virtual machines. Other management processes are possible.

In embodiments, more than one set of virtual machines can be instantiated in a given cloud at the same, overlapping or successive times. The cloud management system 104 can, in such implementations, build, launch and manage multiple sets of virtual machines based on the same or different underlying set of resource servers 108, with populations of different instantiated virtual machines 116 such as may be requested by different users. The cloud management system 104 can institute and enforce security protocols in a cloud 102 hosting multiple sets of virtual machines. Each of the individual sets of virtual machines can be hosted in a respective partition or sub-cloud of the resources of the main cloud 102. The cloud management system 104 of a cloud can for example deploy services specific to isolated or defined sub-clouds, or isolate individual workloads/processes within the cloud to a specific sub-cloud. The subdivision of the cloud 102 into distinct transient sub-clouds or other sub-components which have assured security and isolation features can assist in establishing a multiple user or multi-tenant cloud arrangement. In a multiple user scenario, each of the multiple users can use the cloud platform as a common utility while retaining the assurance that their information is secure from other users of the overall cloud system. In further embodiments,.sub-clouds can nevertheless be configured to share resources, if desired.

In embodiments, and as also shown in FIG. 2, the set of instantiated virtual machines 116 generated in a first cloud 102 can also interact with a set of instantiated virtual machines or processes generated in a second, third or further cloud 102. The cloud management system 104 of a first cloud 102 can interface with the cloud management system 104 of a second cloud 102, to coordinate those domains and operate the clouds and/or virtual machines or processes on a combined basis. The cloud management system 104 of a given cloud 102 can track and manage individual virtual machines or other resources instantiated in that cloud, as well as the set of instantiated virtual machines or other resources in other clouds.

In the foregoing and other embodiments, the user making an instantiation request or otherwise accessing or utilizing the cloud network can be a person, customer, subscriber, administrator, corporation, organization, or other entity. In embodiments, the user can be or include another virtual machine, application or process. In further embodiments, multiple users or entities can share the use of a set of virtual machines or other resources.

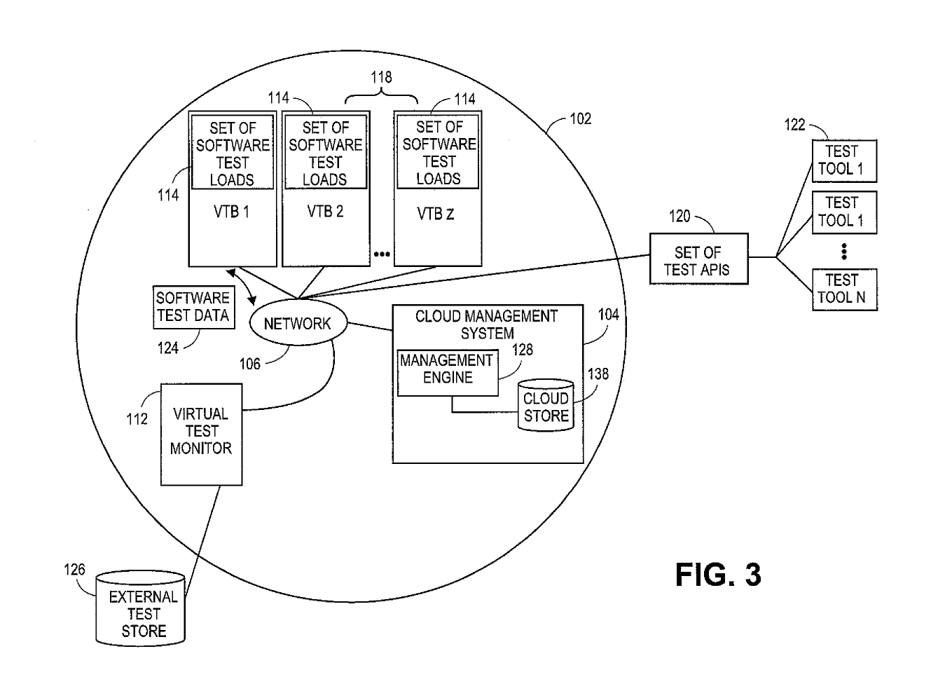

FIG. 3 illustrates an overall architecture in which systems and methods for software test management in a cloud-based network can operate, according to various embodiments. In embodiments as shown, a set of virtual test beds 118 can be instantiated in cloud 102 via cloud management system 104. The set of virtual test beds 118 can be requested, for example, by a software developer or other operator or user. The set of virtual test beds 118 can include or consist of, for example, a set of virtual servers. The virtual servers or other set of virtual test beds 118 can be configured, for example, to act as transaction servers for a retail or commercial Web site, or for other purposes.

Set of virtual test beds 118 are loaded with a set of software test loads 114, representing software to be executed, diagnosed, and tested for development or other purposes. The set of software test loads 114 can include, for example, applications, operating systems, utilities, functions, libraries, modules, or other software or code. In embodiments, the set of software test loads 114 can include software at different stages of development or revision. For instance, software in set of software test loads 114 can include software designated as being in a beta stage. Software in set of software test loads 114 can also include software that has already been released, distributed or commercialized, including software which has been assigned an engineering version number. The set of software test loads 114 can further include revisions, updates, or other modifications to existing software.

In addition to the set of virtual test beds 118, a virtual test monitor 112 can also be instantiated in cloud 102. Virtual test monitor 112 can include operating system, input/output, processing and other resources to communicate with set of virtual test beds 118 via network 106, and monitor a configuration or execution state of the set of virtual test beds 118. The virtual test monitor 112 can exchange software test data 124 with set of virtual test beds 118 to load, initiate, execute, and monitor the configuration or execution state of the set of software test loads 114. The software test data 124 can for example include information describing the execution state including program faults or hangs, memory conditions including leakage or cache performance, input/output information such as the usage of ports, and performance information such as transactions per second being processing by set of virtual test beds 118 while running set of software test loads 114. In embodiments, software test data 124 and related information can be encoded in extensible markup language (XML) code for exchange with set of virtual test beds 118 and other resources.

A set of test APIs 120 is also presented to the set of virtual test beds 118, set of software test loads 114, and/or virtual test monitor 112. The set of test APIs 120 can be installed and presented via cloud management system 104, via virtual test monitor 112, or other resources. The set of test APIs 120 can include a set of function or procedure calls, through which a set of test tools 122 can interrogate and communicate with the set of software test loads 112 and/or the data being operated on by set of software test loads 114. The set of test tools 122 can include software diagnostic applications and utilities, such as development tools that measure the performance, reliability, data compatibility, operating system compatibility, and other characteristics of the software under test. In embodiments, the set of test tools 122 can be selectable or extensible, for example at the choice of the software developer. In embodiments, the set of test tools 122 can be installed in the cloud 102 by cloud management system 104, or can be hosted in servers or other platforms external to cloud 102.

In embodiments, the virtual test monitor 112 can initiate and manage any software test cycles desired by the software developer or other user or operator. The set of test tools 122 can for instance be configured to take performance or other metrics on set of software test loads 114 for an hour, day or other period based on one or more data sets, or other inputs or conditions. In instances, the software developer or other user or operator may subject set of software test loads 114 to various stress tests designed to locate program bugs, incompatibilities or other areas for modification or improvement. According to embodiments, the virtual test monitor 112 can store associated program test data 124 to an external test store 126, such as a database hosted outside cloud 102 to generate a record of software development and test activity.

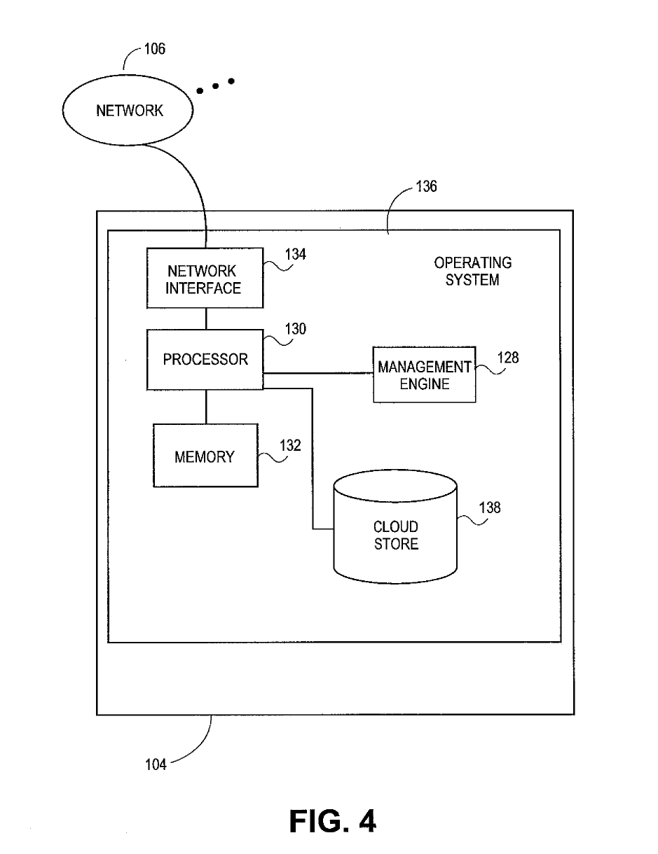

FIG. 4 illustrates an exemplary diagram of hardware and other resources that can be incorporated in a cloud management system 104 configured to communicate with resources including virtual test monitor 112, set of instantiated virtual machines 116 and set of virtual test bed 118 via one or more networks 106, according to embodiments. In embodiments as shown, cloud management system 104 can comprise a processor 130 communicating with memory 132, such as electronic random access memory, operating under control of or in conjunction with operating system 136. Operating system 136 can be, for example, a distribution of the Linux™ operating system, the Unix™ operating system, or other open-source or proprietary operating system or platform. Processor 130 also communicates with cloud store 138, such as a database stored on a local hard drive. Processor 130 further communicates with network interface 134, such as an Ethernet or wireless data connection, which in turn communicates with one or more networks 106, such as the Internet or other public or private networks. Processor 130 also communicates with cloud store 138 and management engine 128, to execute control logic and control the operation of virtual machines and other resources in cloud 102. Other configurations of cloud management system 104, associated network connections, and other hardware and software resources are possible.

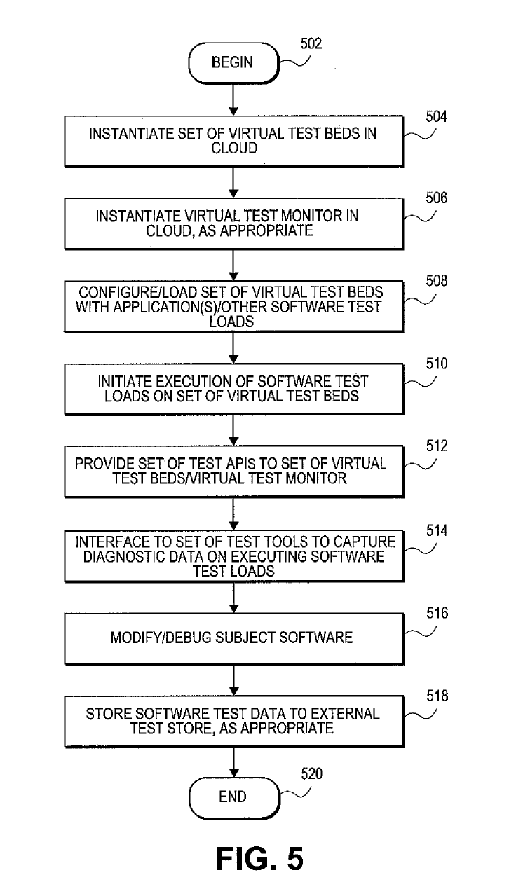

FIG. 5 illustrates a flowchart of overall software diagnostic processing, according to various embodiments of the present teachings. In step 502, processing can begin. In step 504, a set of virtual test beds 118 can be instantiated in cloud 102 via cloud management system 104, for example at the request of a software developer or other user. In step 506, a virtual test monitor 112 can be instantiated in cloud 102 via cloud management system 104. The virtual test monitor can communicate with set of virtual test beds 118 via one or more networks 106.

In step 508, the set of virtual test beds 118 can be configured or loaded with set of software test loads 114. Set of software test loads 114 can include, for example, applications, programs, operating systems, utilities, functions, libraries, modules or other software. In embodiments, set of software test loads 114 can be compiled or assembled in executable form for distribution to and execution on set of virtual test beds 118. In embodiments, set of software test loads 114 can include applications or other software in a beta or other test or development stage, or finished software products. In step 510, initiation of set of software test loads 114 can be begun, for example under control of virtual test monitor 112. In step 512, set of test APIs 120 can be provided to set of virtual test beds 118 and/or virtual test monitor 112, to permit the exchange of information regarding the execution state and results of set of software test loads 114.

In step 514, set of virtual test beds 118 that are hosting and executing set of software test loads 114 can interface to a set of test tools 122 via set of test APIs 120. The set of test tools 122 can receive software test data 124, including information regarding the state of set of software test loads 114, such as the execution state including fault conditions, the input/output state of the executing software, memory conditions, interactions with other software, performance metrics and other data related to the set of software test loads 114. In step 516, the software developer or other user or entity can modify or debug the applications or other software forming set of software test loads 114, such as by modifying code or libraries. In step 518, virtual test monitor 112, cloud management system 104 or other control modules can store software test data 124 to external test store 126 or other storage. In step 520, as understood by persons skilled in the art, processing can repeat, return to a prior processing point, jump to a further processing point, or end.

The foregoing description is illustrative, and variations in configuration and implementation may occur to persons skilled in the art. For example, while embodiments have been described in which a single or uniform set of software test loads 114 are installed and executed on set of virtual test beds 118, in embodiments, different software applications or software test loads 114 can be loaded on different test beds in the set of virtual test beds 118. For further example, while embodiments have been described in which set of virtual test beds 118 comprise a set of identically configured virtual servers or other virtual machines, in embodiments, different virtual machines in set of virtual test beds 118 can be configured differently. For yet further example, while embodiments have been described which operate under the control or monitoring of a single virtual test monitor 112, in embodiments, multiple test monitors can track and manage the progress of software testing, debugging, and other software life cycle processing. In implementations, when multiple text monitors are employed, those monitors can be virtual machines, on-premise physical machines, or combinations of the two.

For still further example, while embodiments have been described in which software test and development data can be stored to a single external test store 126, in embodiments that information can be stored to multiple external data stores, and/or to cloud store 138 or other resources of cloud management system 104. Other resources described as singular or integrated can in embodiments be plural or distributed, and resources described as multiple or distributed can in embodiments be combined. The scope of the present teachings is accordingly intended to be limited only by the following claims.

What is claimed is:

1. A method of evaluating software, comprising:
instantiating a set of virtual test beds in a network cloud;
installing a set of test software on the set of virtual test beds;
executing the set of test software on the set of virtual test beds;
providing an interface between the executing set of test software and a set of software test tools; and
managing the set of test software based on output of the set of software test tools.

2. The method of claim 1, wherein the set of virtual test beds comprises at least one of a set of virtual servers, a set of virtual clients, and a set of virtual appliances.

3. The method of claim 1, wherein the set of test software comprises at least one of software applications, software utilities, software modules, and operating system software.

4. The method of claim 1, wherein the executing comprises at least one of executing the set of test software with a set of predetermined data inputs, executing the set of test software by interacting with other software, executing the set of test software by interacting with an operating system, and executing the set of test software using a predetermined range of processing throughput.

5. The method of claim 1, wherein the interface between the executing set of test software and the set of software test tools comprises a set of application programming interfaces.

6. The method of claim 1, wherein the set of software test tools comprise a set of virtual tools instantiated in the network cloud.

7. The method of claim 1, wherein the set of software test tools comprise a set of tools installed on a set of on-premise machines.

8. The method of claim 1, wherein the managing comprises storing results of the executing to a test store external to the network cloud.

9. The method of claim 1, wherein the managing comprises modifying the set of test software based on results of the executing.

10. A system for evaluating software, comprising:
an interface to a set of virtual test beds instantiated in a network cloud; and
a test management module, communicating with the interface to the set of virtual test beds, the test management module being configured to-initiate the installation of a set of test software on the set of virtual test beds,
initiate the execution of the set of test software on the set of virtual test beds,
provide an interface between the executing set of test software and a set of software test tools, and
manage the set of test software based on output of the set of software test tools.

11. The system of claim 10, wherein the set of virtual test beds comprises at least one of a set of virtual servers, a set of virtual clients, and a set of virtual appliances.

12. The system of claim 10, wherein the set of test software comprises at least one of software applications, software utilities, software modules, and operating system software.

13. The system of claim 10, wherein the execution of the set of test software comprises at least one of executing the set of test software with a set of predetermined data inputs, executing the set of test software by interacting with other software, executing the set of test software by interacting with an operating system, and executing the set of test software using a predetermined range of processing throughput.

14. The system of claim 10, wherein the interface between the executing set of test software and the set of software test tools comprises a set of application programming interfaces.

15. The system of claim 10, wherein the set of software test tools comprise a set of virtual tools instantiated in the network cloud.

16. The system of claim 10, wherein the set of software test tools comprise a set of tools installed on a set of on-premise machines.

17. The system of claim 10, wherein the test management module comprises a virtual test management module instantiated in the network cloud.

18. The system of claim 10, wherein the test management module is configured as part of a cloud management system.

19. A software product, the software product being generated by a software evaluation method comprising:
instantiating a set of virtual test beds in a network cloud;
installing a set of test software on the set of virtual test beds;
executing the set of test software on the set of virtual test beds;
providing an interface between the executing set of test software and a set of software test tools; and
generating the software product based on output of the set of software test tools.

20. The software product of claim 19, wherein the set of virtual test beds comprises at least one of a set of virtual servers, a set of virtual clients, and a set of virtual appliances.

21. The software product of claim 19, wherein the generating comprises modifying the set of test software based on the output of the set of software test tools.

22. The software product of claim 19, wherein the executing comprises at least one of executing the set of test software with a set of predetermined data inputs, executing the set of test software by interacting with other software, executing the set of test software by interacting with an operating system, and executing the set of test software using a predetermined range of processing throughput.
